(19) United States
(12) Patent Application Publication
(10) Pub. No.: US 2015/0012691 A1
(43) Pub. Date: Jan. 8, 2015

(54) STORAGE CONTROL APPARATUS, CONTROL PROGRAM, AND CONTROL METHOD

(71) Applicant: FUJITSU LIMITED, Kawasaki-shi (JP)

(72) Inventor: Yuichiro Yamaguchi, Kahoku (JP)

(73) Assignee: FUJITSU LIMITED, Kawasaki-shi (JP)

(21) Appl. No.: 14/299,578

(22) Filed: Jun. 9, 2014

(30) Foreign Application Priority Data
Jul. 5, 2013 (JP) 2013-142023

(51) Int. Cl. G06F 3/06

(52) U.S. Cl. CPC G06F 3/0659; G06F 3/0604; G06F 3/0679
USPC 711/103

(57) ABSTRACT

A storage control apparatus which receives a command from a higher-level apparatus for a storage volume constructed by a plurality of storage devices one of which is a first storage device in which physically erasing data is performed on an area in which undesired data is stored in advance in preparation for next write and controls the storage devices, the storage control apparatus includes an identifying section configured to identify, as an erasing area, the area in which undesired data is stored in the first storage device, and an instructing section configured to instruct the first storage device to erase data in the erasing area identified by the identifying section.

### CROSS-REFERENCE TO RELATED APPLICATION

This application is based upon and claims the benefit of priority of the prior Japanese Patent Application No. 2013-142023, filed on Jul. 5, 2013, the entire contents of which are incorporated herein by reference.

### FIELD

The embodiments discussed herein are related to a storage control apparatus, a control program, and a control method.

### BACKGROUND

In recent years, as the capacity of flash memories has been increased, solid state drives (SSDs) have been more commonly used for storage apparatuses. However, there is a structural defect of SSDs in which, when an SSD is continuously used, write performance is degraded. The reason why reduction in write performance occurs is that, when rewrite of data is performed, operations of write processing become complicated and it takes a long time to perform the operations.

When used areas increase in an SSD, rewrite of data is performed for an increased number of times, and thus, write performance is degraded. A used area herein is an area which is a non-use area in terms of file system management but in which old data physically remains. To make up for the defect, there is a Trim command (an erasing command). A Trim command is a command to cause a host (an operation system OS) to notify an SSD of non-use areas and promotes physically erasing data in advance in preparation for next write. Write to an area in which data has been erased is performed by a single operation, and thus, write performance is improved by using the Trim command. Therefore, in general, when a file is erased, a Trim command is issued along with the erasing.

There is a related art technique in which an interface for use in issuing a Trim command is provided in a solid state storage device (see, for example, Japanese National Publication of International Patent Application No. 2013-504142). Another related art is a technique in which an SSD and a hard disk drive (an HDD) are used as storage mediums of a storage system (see, for example, Japanese National Publication of International Patent Application No. 2011-515727).

However, a problem arises in which, when both of the SSD and the HDD are used as storage mediums, an undesired Trim command is issued and overhead of processing occurs. FIG. 15 is a diagram illustrating an undesired Trim command issued from a host.

As illustrated in FIG. 15, a storage apparatus 92 includes a controller module (CM) 93, a SSD 94a, and a HDD 94b. The CM 93 receives a command from a host 91 and controls, based on the received command, the storage apparatus 92. Each of the SSD 94a and the HDD 94b is a storage medium that stores data.

The storage apparatus 92 has an automatic hierarchy function of allocating a data destination to the SSD 94a or the HDD 94b, based on frequency of use of data. Accordingly, to the host 91 it looks that there is a single volume, and therefore, the storage apparatus 92 presents, to the host 91, a logical volume 94 as the SSD. Thus, there might be cases where, when a Trim command is issued for a used area, the host 91 issues a Trim command to the HDD 94b, that is, the host 91 issues an undesired Trim command.

In an aspect, it is an object of the present disclosure to reduce overhead due to processing of an undesired Trim command.

### SUMMARY

According to an aspect of the invention, a storage control apparatus which receives a command from a higher-level apparatus for a storage volume constructed by a plurality of storage devices one of which is a first storage device in which physically erasing data is performed on an area in which undesired data is stored in advance in preparation for next write and controls the storage devices, the storage control apparatus includes an identifying section configured to identify, as an erasing area, the area in which undesired data is stored in the first storage device, and an instructing section configured to instruct the first storage device to erase data in the erasing area identified by the identifying section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a storage apparatus according to a first embodiment;

FIG. 2 is a diagram illustrating a functional structure of a CM according to the first embodiment;

FIG. 3 is a diagram illustrating a management information area in which file management information is stored;

FIG. 4A is a diagram illustrating an example of information stored in a super block;

FIG. 4B is a diagram illustrating an example of information stored in a free space management area;

FIG. 4C is a diagram illustrating an example of information stored in an i node;

FIG. 4D is a diagram illustrating an example of information stored in a directory data area;

FIG. 5 is a diagram illustrating an example of determination information;

FIG. 6 is a flow chart illustrating a sequence of performance improving processing;

FIG. 7 is a flow chart illustrating a flow of performance improving processing performed by a second control section;

FIG. 8 is a diagram illustrating data damage due to performance improving processing;

FIG. 9 is a diagram illustrating a configuration of a storage apparatus according to a second embodiment;

FIG. 10 is a diagram illustrating a functional structure of a CM according to the second embodiment;

FIG. 11 is a flow chart illustrating a processing sequence performed when a write request is made during performance improving processing;

FIG. 12 is a flow chart illustrating a first processing sequence performed when a read request is made during performance improving processing;

FIG. 13 is a flow chart illustrating a second processing sequence performed when a read request is made during performance improving processing;

FIG. 14 is a flow chart illustrating a flow of processing performed by a first control section when a command is received from a host in a command pool use mode; and

FIG. 15 is a diagram illustrating an undesired Trim command issued from a host.

### DESCRIPTION OF EMBODIMENTS

Embodiments of a storage control apparatus, a control program, and a control method according to the present disclosure are described in detail below with reference to the accompanying drawings. Note that the embodiments described below are not intended to limit the technical scope of the present disclosure.

### First Embodiment

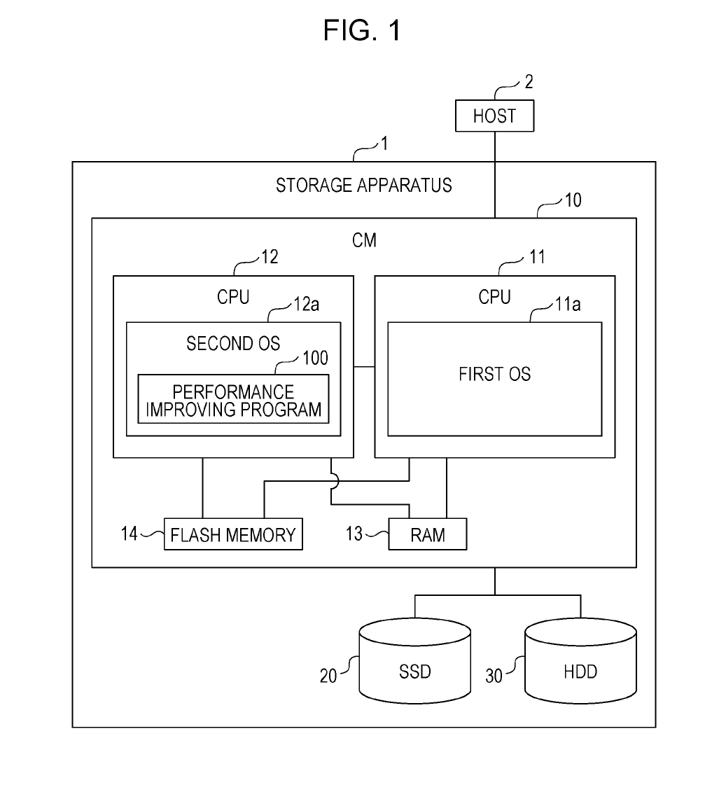

First, a configuration of a storage apparatus according to a first embodiment is described. FIG. 1 is a diagram illustrating a configuration of a storage apparatus according to the first embodiment. As illustrated in FIG. 1, a storage apparatus 1 includes a CM 10, an SSD 20, and an HDD 30.

The CM 10 controls the storage apparatus 1, based on an instruction sent from a host 2. The SSD 20 is a storage device using a flash memory as a storage medium. The HDD 30 is a storage device using a magnetic disk as a storage medium.

The CM 10 includes a CPU 11, a CPU 12, a random access memory (RAM) 13, and a flash memory 14. Each of the CPU 11 and the CPU 12 is a central processing unit that reads out a program from the flash memory 14 to execute the program. The RAM 13 is a memory that stores data stored in the SSD 20 and HDD 30 and data used by the CPU 11 and the CPU 12 in performing processing. The flash memory 14 is a memory that stores a program executed in the CPU 11 and the CPU 12.

In the CPU 11, a first operating system (OS) 11a used for controlling the storage apparatus 1 is executed. In the CPU 12, a second OS 12a including a file system used by the host 2 is executed. The second OS 12a mounts the SSD 20 using the file system used by the host 2. The second OS 12a mounts the SSD 20 using the file system used by the host 2, and thereby, a program executed by the second OS 12a is interpreted with reference to management information managed by the file system used by the host 2.

A performance improving program 100 is a program executed by the second OS 12a. The performance improving program 100 identifies a used area of the SSD 20 and issues a Trim command to the SSD 20 via the first OS 11a in order to erase data in the used area. The performance improving program 100 is started based on an instruction of the first OS 11a.

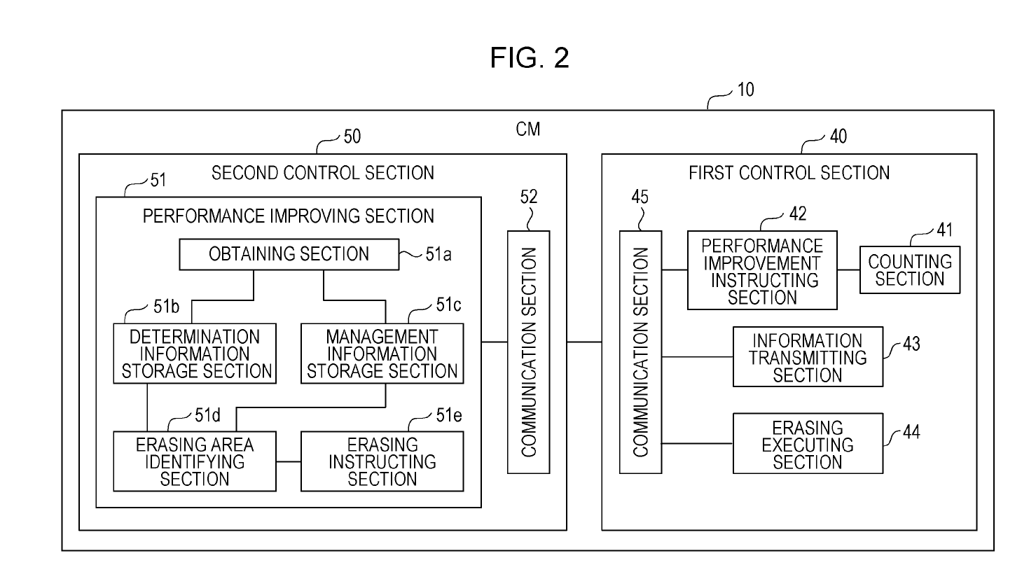

Next, a functional structure of the CM 10 according to the first embodiment is described. FIG. 2 is a diagram illustrating a functional structure of the CM 10 according to the first embodiment. As illustrated in FIG. 2, the CM 10 includes a first control section 40 and a second control section 50. The first control section 40 controls the storage apparatus 1. The function of the first control section 40 is realized by execution of the first OS 11a and a program controlled by the first OS 11a by the CPU 11.

The first control section 40 includes a counting section 41, a performance improvement instructing section 42, an information transmitting section 43, an erasing executing section 44, and a communication section 45. The counting section 41 counts the total number of sectors in which data is written in the SSD 20. One sector herein is 512 bytes (B).

The performance improvement instructing section 42 determines whether or not the number of sectors counted by the counting section 41 has exceeded 90% of the capacity of the SSD 20 and, if exceeded, the performance improvement instructing section 42 instructs the second control section 50 to start performance improving processing. The performance improving processing herein is processing in which a Trim command is issued for a used area of the SSD 20 to improve write performance of the SSD 20.

The information transmitting section 43 transmits, based on a request sent from the second control section 50, management information for a file stored in a disk device, and determination information used for determining whether an area of the disk device is an area belonging to the SSD 20 or an area belonging to the HDD 30, to the second control section 50. The disk device herein is a storage device including the SSD 20 and the HDD 30 combined together.

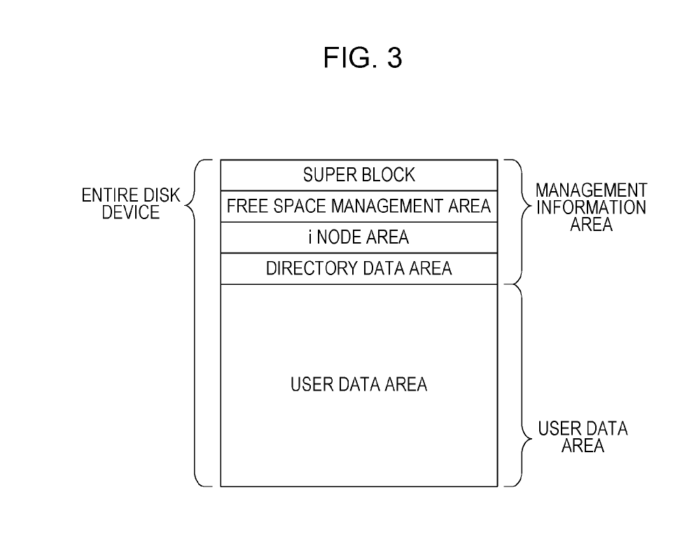

FIG. 3 is a diagram illustrating a management information area in which file management information is stored. As illustrated in FIG. 3, the management information area occupies a head part of a storage area of the entire disk device and the rest of the storage area is a user data area in which user data is stored. The management information area includes a super block, a free space management area, an i node area, and a directory data area.

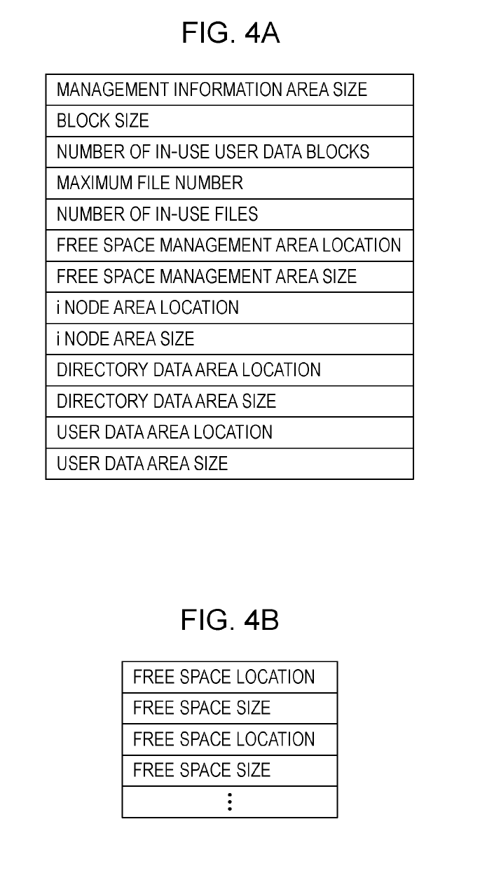

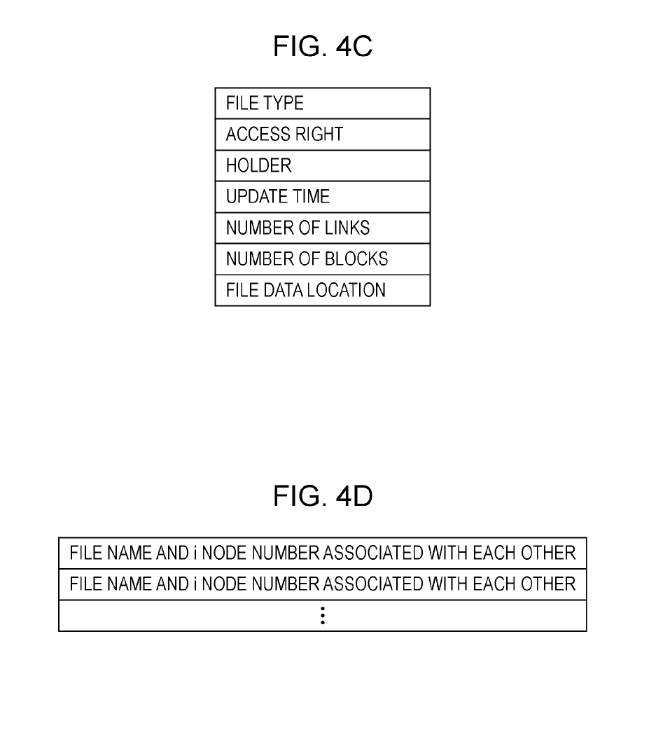

FIG. 4A is a diagram illustrating an example of information stored in the super block. As illustrated in FIG. 4A, information stored in the super block includes a management information area size, a block size, the number of in-use user data blocks, a maximum file number, the number of in-use files, a free space management area location, and a free space management area size. Information stored in the super block includes an i node area location, an i node area size, a directory data area location, a directory data area size, a user data area location, and a user data area size.

The management information area size indicates the size of the management information area, and the block size indicates the size of a block, which is an area management unit in a file system. The block size herein is 4 kilo bytes (KB). The number of in-use user data blocks is the number of blocks used as storage areas for user data. The maximum file number indicates the maximum number of files that the file system stores, and the number of in-use files is the number of files that the file system stores.

The free space management area location indicates a starting location of the free space management area, which is an area that manages a free space, with a block number, and the free space management area size indicates the size of the free space management area with the number of blocks. The i node area location indicates a starting location of the i node area, which is an area in which i node information is stored, with a block number, and the i node area size indicates the size of an i node area with the number of blocks.

The directory data area location indicates a starting location of the directory data area, which is an area in which directory data is stored, with a block number, and the directory data area size indicates the size of the directory data area with the number of blocks. The user data area location indicates a starting location of the user data area in which user data is stored with a block number, and the user data area size indicates the size of the user data area with the number of blocks.

FIG. 4B is a diagram illustrating an example of information stored in the free space management area. As illustrated in FIG. 4B, information stored in the free space management area includes the location of a free space and the size of the free space for the number of free spaces. The free space location indicates a starting location of a free space with a block number, and the free space size indicates the size of a free space with the number of blocks. Note that the used area is managed as a free space.

FIG. 4C is a diagram illustrating an example of information stored in an i node that an i node area stores for each file. As illustrated in FIG. 4C, information stored in an i node that an i node area stores for each file includes a file type, an access right, a holder, an update time, the number of links, the number of blocks, and a file data location.

The file type indicates the type of a file. The access right indicates information for a right for accessing a file. The holder indicates the holder of a file. The update time indicates the final update data and time of a file. The number of links is the number of files that refer to i node information. The number of blocks indicates the size of a file with the number of blocks. The file data location indicates a starting location of file data with a block number.

FIG. 4D is a diagram illustrating an example of information stored in the directory data area. As illustrated in FIG. 4D, as information stored in the directory data area, directory data including the name of a file and an i node number that stores the information for the file associated with each other is stored for the number of directories.

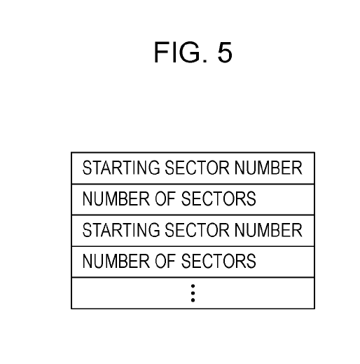

FIG. 5 is a diagram illustrating an example of determination information. As illustrated in FIG. 5, the determination information includes a starting sector number and the number of sectors for the number of areas in the SSD 20. The starting sector number indicates a starting location of each area in the SSD 20 with a sector number, and the number of sectors indicates the size of the area with the number of sectors.

Returning to FIG. 2, the erasing executing section 44 erases data in an used area of the SSD 20, based on a Trim command issued by the second control section 50. The erasing executing section 44 identifies the corresponding sector number to erase the data of the used area. The communication section 45 performs communication with the second control section 50.

The second control section 50 supports the file system as that of the host 2 and interprets management information illustrated in FIG. 3, FIG. 4A, and FIG. 4B. The function of the second control section 50 is realized by execution of the second OS 12a and a program controlled by the second OS 12a by the CPU 12.

The second control section 50 includes a performance improving section 51 and a communication section 52. The performance improving section 51 executes performance improving processing. The performance improving section 51 includes an obtaining section 51a, a determination information storage section 51b, a management information storage section 51c, an erasing area identifying section 51d, and an erasing instructing section 51e. Note that the function of performance improving section 51 is realized by execution of the performance improving program 100 under the control of the second OS 12a.

The obtaining section 51a receives management information and determination information transmitted by the information transmitting section 43, stores the management information in the management information storage section 51c, and the determination information in the determination information storage section 51b. The determination information storage section 51b stores the determination information, and the management information storage section 51c stores the management information.

The erasing area identifying section 51d identifies an erasing area of the SSD 20, based on the determination information stored by the determination information storage section 51b and the management information stored by the management information storage section 51c. Specifically, the erasing area identifying section 51d converts, for each sector included in the determination information, sector location information to block location information to determine whether or not each sector is included in a free area, and identifies a sector included in the free area as an erasing area. The erasing area identifying section 51d identifies the erasing area of the SSD 20, based on the determination information and the management information, and thereby, the performance improving section 51 improves performance of write processing.

The erasing instructing section 51e instructs the first control section 40 to erase data in the erasing area identified by the erasing area identifying section 51d. Specifically, the erasing instructing section 51e issues a Trim command to the sector identified by the erasing area identifying section 51d.

The communication section 52 performs communication with the first control section 40. Note that communication between the communication section 45 and the communication section 52 is realized as inter-CPU communication between the CPU 11 and the CPU 12.

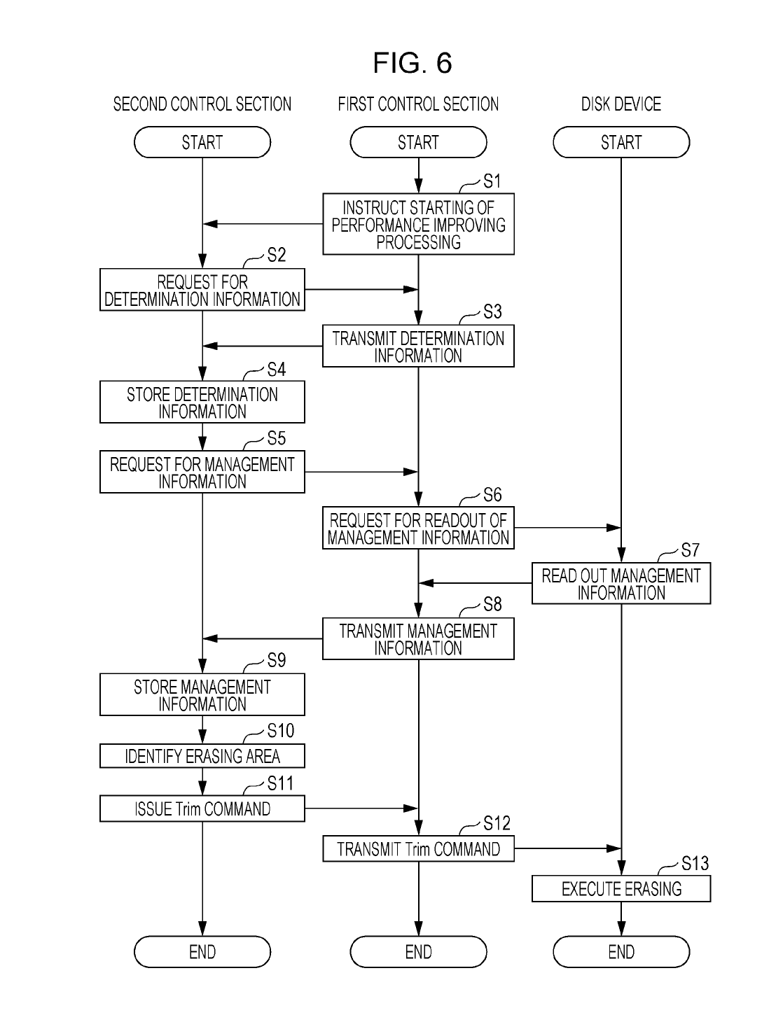

Next, a sequence of performance improvement processing is described. FIG. 6 is a flow chart illustrating a sequence of performance improving processing. As illustrated in FIG. 6, when the ratio of sectors in which data is written to all sectors of the SSD 20 exceeds 90%, the first control section 40 instructs the second control section 50 to start performance improving processing (Operation S1).

Then, the second control section 50 requests the first control section 40 for transmitting determination information (Operation S2). The first control section 40 transmits determination information to the second control section 50 (Operation S3). The second control section 50 receives the determination information to store it in the determination information storage section 51b (Operation S4).

Then, the second control section 50 requests the first control section 40 for transmitting management information (Operation S5). The first control section 40 requests the disk device for reading out management information (Operation S6), and the disk device reads out management information (Operation S7) to send it to the first control section 40. The first control section 40 transmits the management information to the second control section 50 (Operation S8). The second control section 50 receives the management information to store it in the management information storage section 51c (Operation S9).

Then, the second control section 50 identifies an erasing area, based on the determination information and the management information (Operation S10), and issues a Trim command for the identified erasing area (Operation S11). The first control section 40 receives the Trim command and transmits the Trim command to the disk device (Operation S12). The disk device executes erasing of data in a sector identified by the Trim command (Operation S13). Note that processing of Operations S11-S13 is repeated in accordance with the number of sectors included in the erasing area.

Thus, the second control section 50 identifies an erasing area and instructs the first control section 40 to erase data in the erasing area, and thereby, the second control section 50 improves performance of writing operation of the SSD 20.

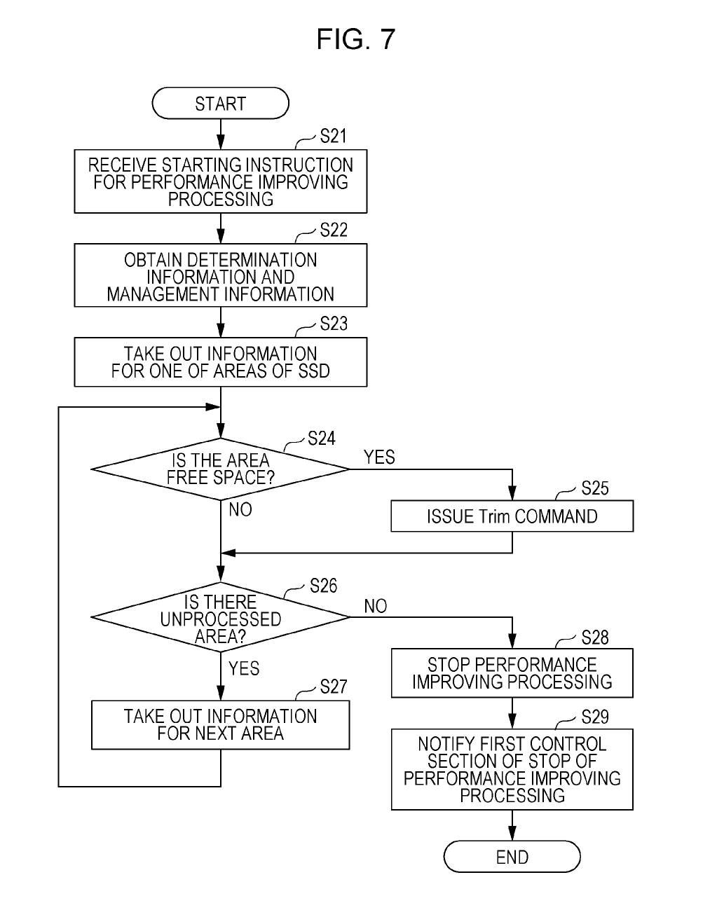

Next, a flow of performance improvement processing performed by the second control section 50 is described. FIG. 7 is a flow chart illustrating a flow of performance improving processing performed by the second control section 50. As illustrated in FIG. 7, the second control section 50 receives a starting instruction for performance improving processing from the first control section 40 (Operation S21).

Then, the performance improving section 51 obtains determination information and management information from the first control section 40 (Operation S22). The performance improving section 51 takes out information for one of areas of the SSD 20 from the determination information (Operation S23) and determines whether or not the area for which the information has been taken out is a free space using the management information (Operation S24).

As a result, if the area is a free space, the performance improving section 51 issues a Trim command for the free space (Operation S25). The performance improving section 51 determines then whether or not there is an unprocessed area (Operation S26) and takes out, if there is an unprocessed area, information for a next area from the determination information (Operation S27), and the process returns to Operation S24.

On the other hand, if there is not an unprocessed area, the performance improving section 51 stops performance improving processing (Operation S28), and the second control section 50 notifies the first control section 40 of stop of performance improving processing (Operation S29).

Thus, the performance improving section 51 issues a Trim command for a free space of the SSD 20, and thus, write performance of data write to the SSD 20 is improved.

As described above, in the first embodiment, the obtaining section 51a obtains determination information and management information from the first control section 40 and stores the determination information and the management information in the determination information storage section 51b and the management information storage section 51c, respectively. Then, the erasing area identifying section 51d identifies an erasing area, based on the determination information and the management information stored by the determination information storage section 51b and the management information storage section 51c, respectively, and the erasing instructing section 51e issues a Trim command for the erasing area. Thus, instead of a host, the CM 10 that comprehends the internal structure of the storage apparatus issues a Trim command only to the SSD 20, and overhead due to processing of an undesired Trim command to the HDD 30 is minimized. The host does not have to issue a Trim command.

In the first embodiment, the counting section 41 counts the total number of sectors in which data is written in the SSD 20 and, if the number of sectors counted by the counting section 41 exceeds 90% of the capacity of the SSD 20, the performance improvement instructing section 42 instructs the second control section 50 to start performance improvement processing. Thus, the CM 10 executes performance improving processing before deterioration of write performance of data write to the SSD 20 occurs.

In the first embodiment, the second OS 12a mounts the SSD 20 using the same file system as the file system used by the host 2, and thus, the performance improving section 51 performs interpretation with reference management information managed by the file system used by the host 2.

### Second Embodiment

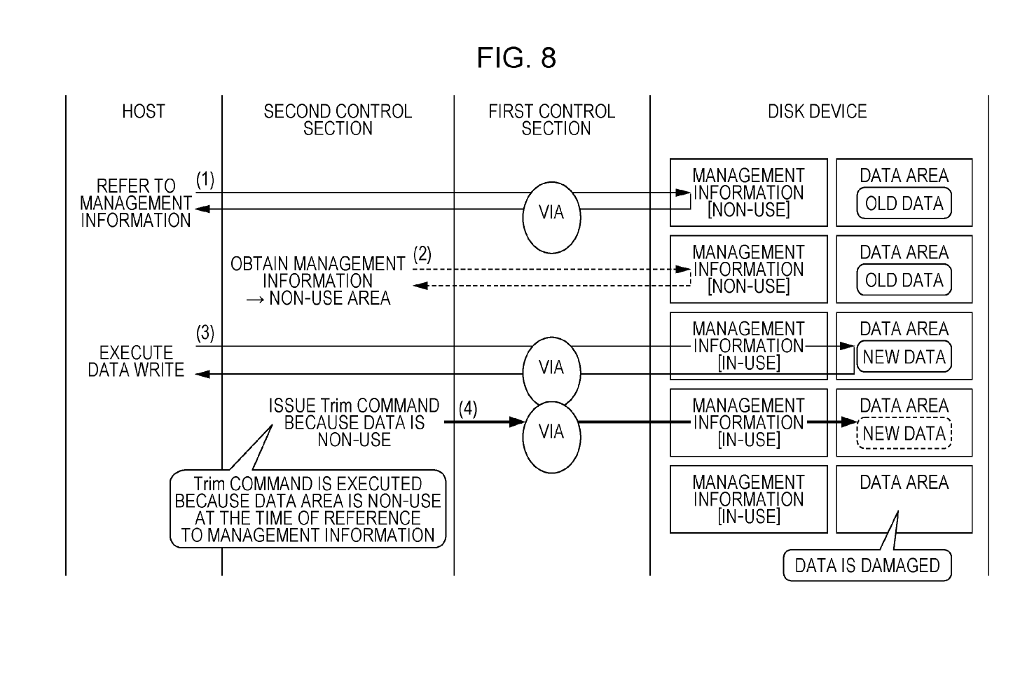

Incidentally, in the first embodiment, depending on timing with which performance improving processing is executed, the performance improving processing might damage data of the SSD 20. FIG. 8 is a diagram illustrating data damage due to performance improving processing. As illustrated in FIG. 8, when a data write request is generated, the host 2 refers to management information stored by the disk device via the first control section 40 (1). On the other hand, the second control section 50 executes performance improving processing and obtains management information stored by the disk device via the first control section 40 (2).

Then, the host 2 executes data write to a non-use area, based on management information (3). Thus, in a data area in which data write has been performed, new data is written and the management information for the area in which data is written is updated while being used. On the other hand, the second control section 50 determines, based on the management information before update, that the data area in which the new data is written is non-use data, and issues a Trim command for the data area (4). As a result, the data area in which the new data is written is erased and data is damaged.

Thus, when performance improving processing is executed while the storage apparatus is operated, depending on timing with which the performance improving processing is executed, the performance improving processing might damage data of the SSD 20, and therefore, a measure have to be taken so that data is not damaged. In view of the foregoing, in the second embodiment, a storage apparatus as a measure that is to be taken so that data of SSD 20 is not damaged due to performance improving processing is described.

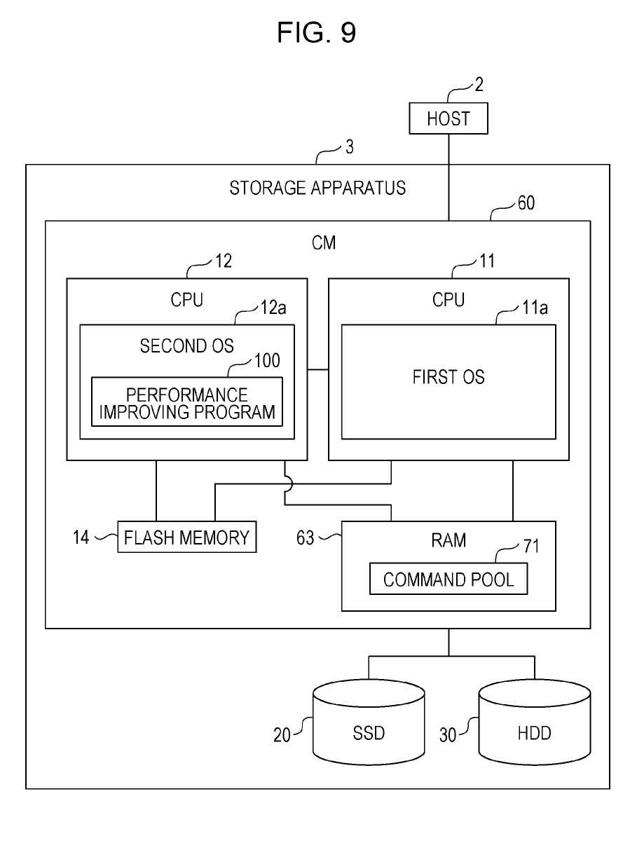

FIG. 9 is a diagram illustrating a configuration of a storage apparatus according to the second embodiment. Note that, for convenience, those parts which are the same as those corresponding parts illustrated in FIG. 1 are denoted by the same reference numerals and the detail description thereof is omitted. As illustrated in FIG. 9, a storage apparatus 3 according to the second embodiment includes a CM 60. The CM 60 controls the storage apparatus 3, based on an instruction sent from the host 2.

The CM 60 includes a RAM 63 that stores data, and the RAM 63 includes a command pool 71. The command pool 71 temporarily stores management information and write data for a write request for data write to the SSD 20 that is under performance improving processing. Note that, even during performance improving processing, a write request for data write to the HDD 30 is executed. Write data stored by the command pool 71 is written in the SSD 20 after performance improving processing is ended.

As described above, for a write request for data write to the SSD 20 that is under performance improving processing, the CM 60 temporarily stores management information and write data in the command pool 71 and executes write processing to the SSD 20 after performance improving processing is ended. Thus, the CM 60 allows data write to be performed such that data in the SSD 20 is not damaged due to performance improving processing.

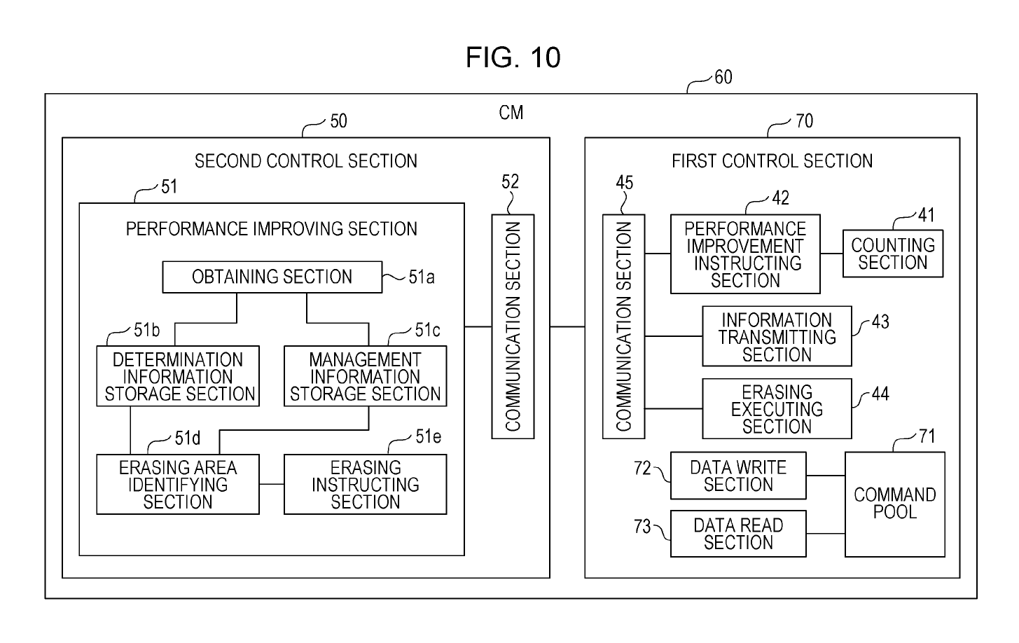

FIG. 10 is a diagram illustrating a functional structure of the CM 60 according to the second embodiment. Note that, for convenience, those parts which are similar to or the same as those corresponding parts illustrated in FIG. 2 are denoted by the same reference numerals and the detail description thereof is omitted. As illustrated in FIG. 10, the CM 60 includes a first control section 70 and a second control section 50.

The first control section 70 includes a command pool 71, a data write section 72, and a data read section 73. The data write section 72 performs data write to a disk device, based on a request sent from the host 2. However, for a request for data write to the SSD 20 that is under performance improving processing, the data write section 72 does not perform data write to the disk device but temporarily stores management information and write data in the command pool 71. When performance improving processing is ended, the data write section 72 takes out the management information and the write data from the command pool 71 and writes data to the SSD 20.

The data read section 73 reads out data from the disk device, based on a request from the host 2. However, for readout of data from the SSD 20 that is under performance improving processing, the data read section 73 determines whether or not there is data stored in the command pool 71. As a result, if there is data stored in the command pool 71, the data read section 73 responds to the host 2 with data stored in the command pool 71 and reads out, if there is not data stored in the command pool 71, data from the SSD 20 and responds to the host 2 with the readout data.

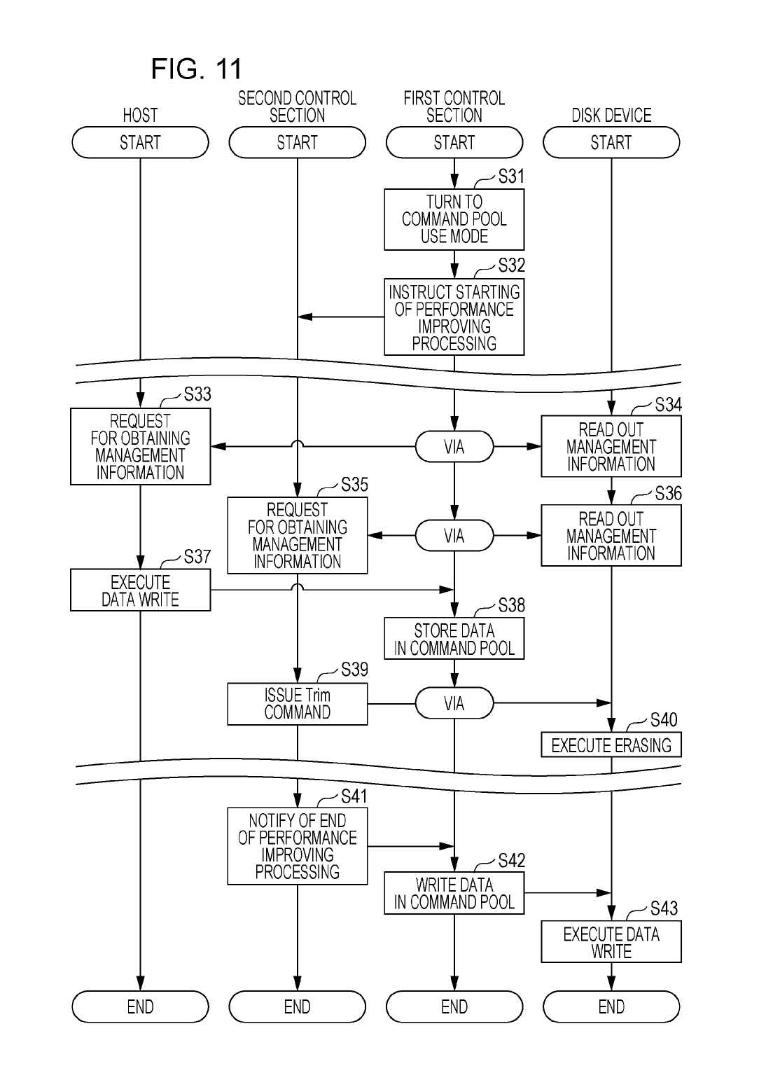

Next, a processing sequence performed when a write request is made during performance improving processing is described. FIG. 11 is a flow chart illustrating a processing sequence performed when a write request is made during performance improving processing. As illustrated in FIG. 11, when the ratio of sectors in which data is written to all sectors of the SSD 20 exceeds 90%, the first control section 70 is turned to a command pool 71 use mode (Operation S31) and instructs the second control section 50 to start performance improving processing (Operation S32).

Thereafter, when, before the second control section 50 obtains management information, a write request is generated in the host 2 and the host 2 requests for obtaining management information (Operation S33), the disk device reads out management information (Operation S34) and transmits the management information to the host 2 via the first control section 70.

Then, when the second control section 50 requests for obtaining management information (Operation S35), the disk device reads out management information (Operation S36) and transmits the management information to the second control section 50 via the first control section 70.

When the host 2 executes data write, based on the obtained management information (Operation S37), the first control section 70 is in a command pool use mode, and therefore, if data write to the SSD 20 is performed, the first control section 70 stores the management information and write data in the command pool 71 (Operation S38).

On the other hand, the second control section 50 identifies an erasing area, based on the obtained management information, and issues, for the identified erasing area, a Trim command to the disk device via the first control section 70 (Operation S39). Then, the disk device executes erasing (Operation S40).

Thereafter, when performance improving processing is ended, the second control section 50 notifies the first control section 70 of end of performance improving processing (Operation S41). Then, the first control section 70 writes data stored in the command pool 71 to the SSD 20 (Operation S42), and the disk device executes data write (Operation S43).

As described above, for a write request for data write to the SSD 20 that is under performance improving processing, the first control section 70 stores management information and write data in the command pool 71 and writes data stored in the command pool 71 to the SSD 20 after performance improving processing is ended. Thus, the CM 60 allows data write to be performed such that data in the SSD 20 is not damaged due to performance improving processing.

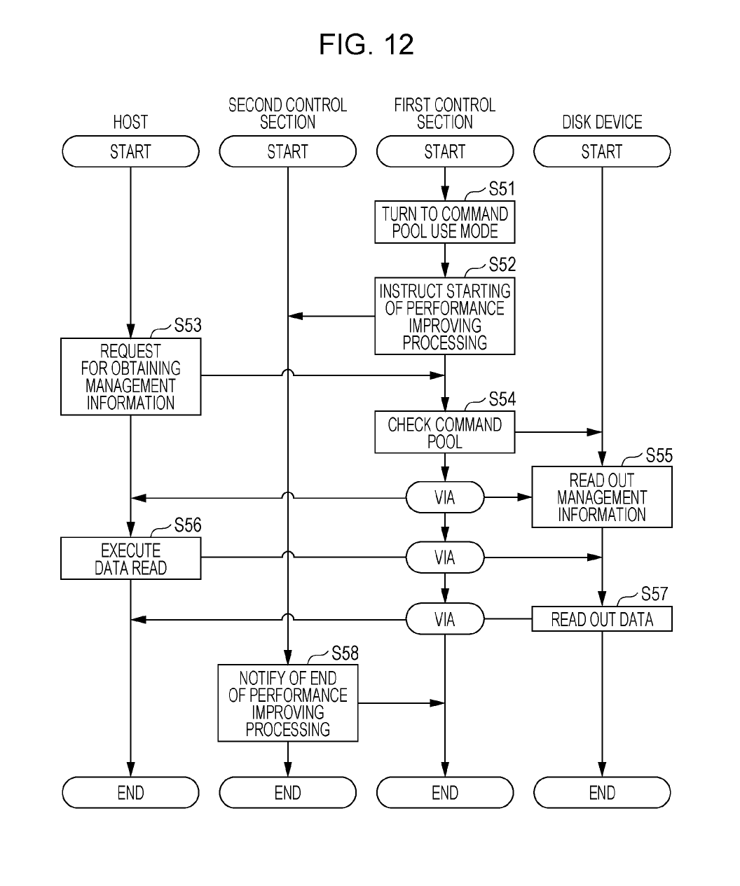

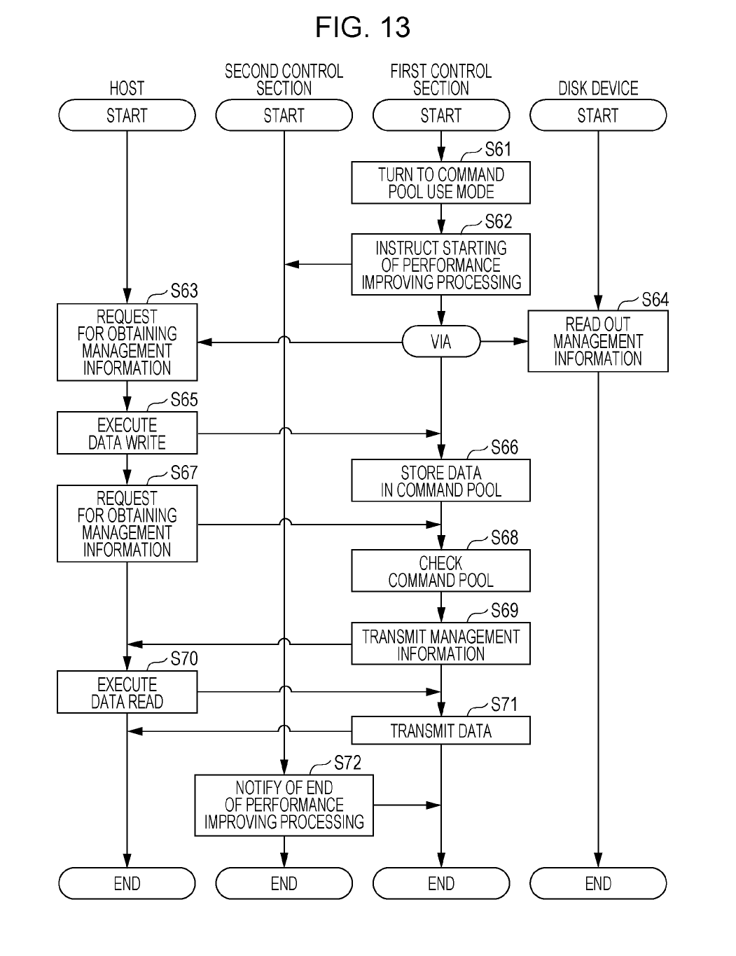

Next, a processing sequence performed when a read request is made during performance improving processing is described. Each of FIG. 12 and FIG. 13 is a flow chart illustrating a processing sequence performed when a read request is made during performance improving processing. FIG. 12 illustrates a sequence performed when data that is to be read is not in the command pool 71, and FIG. 13 illustrates a sequence performed when data that is to be read is in the command pool 71.

As illustrated in FIG. 12, when the ratio of sectors in which data is written to all sectors of the SSD 20 exceeds 90%, the first control section 70 is turned to a command pool 71 use mode (Operation S51) and instructs the second control section 50 to start performance improving processing (Operation S52).

Thereafter, when a write request is generated in the host 2 and the host 2 requests for obtaining management information (Operation S53), the first control section 70 checks the command pool 71 (Operation S54). That is, the first control section 70 determines, based on management information stored in the command pool 71, whether or not there is data that is to be read is in the command pool 71. In this case, since there might be cases where target data is not in the command pool 71, the disk device reads out corresponding management information (Operation S55) and transmits the management information to the host 2 via the first control section 70.

Then, the host 2 executes data write via the first control section 70, based on the management information (Operation S56), the disk device reads out data (Operation S57) and transmits the data to the host 2 via the first control section 70. Thereafter, when performance improving processing is ended, the second control section 50 notifies the first control section 70 of end of performance improving processing (Operation S58).

As illustrated in FIG. 13, when the ratio of sectors in which data is written to all sectors of the SSD 20 exceeds 90%, the first control section 70 is turned to a command pool 71 use mode (Operation S61) and instructs the second control section 50 to start performance improving processing (Operation S62).

Thereafter, when a write request is generated in the host 2 and the host 2 requests for obtaining management information (Operation S63), the disk device reads out corresponding management information (Operation S64) and transmits the management information to the host 2 via the first control section 70.

When the host 2 executes data write, based on the obtained management information (Operation S65), the first control section 70 is in a command pool use mode, and therefore, if data write to the SSD 20 is performed, the first control section 70 stores the management information and write data in the command pool 71 (Operation S66).

Thereafter, when a write request is generated in the host 2 and the host 2 requests for obtaining management information (Operation S67), the first control section 70 checks the command pool 71 (Operation S68). That is, the first control section 70 determines, based on management information stored in the command pool 71, whether or not there is data that is to be read is in the command pool 71. In this case, since there might be cases where target data is not in the command pool 71, the first control section 70 transmits the management information to the host 2 (Operation S69).

The host 2 executes data read based on management information (Operation S70), and first control section 70 reads out data from the command pool 71 and transmits the data to the host 2 (Operation S71). Thereafter, when performance improving processing is ended, the second control section 50 notifies the first control section 70 of end of performance improving processing (Operation S72).

As described above, when a data read request is generated from the host 2 during performance improving processing, the first control section 70 checks the command pool 71 and transmits, if there is target data in the command pool 71, the data of the command pool 71 to host 2. Thus, the host 2 reads out the latest data among data written during performance improving processing.

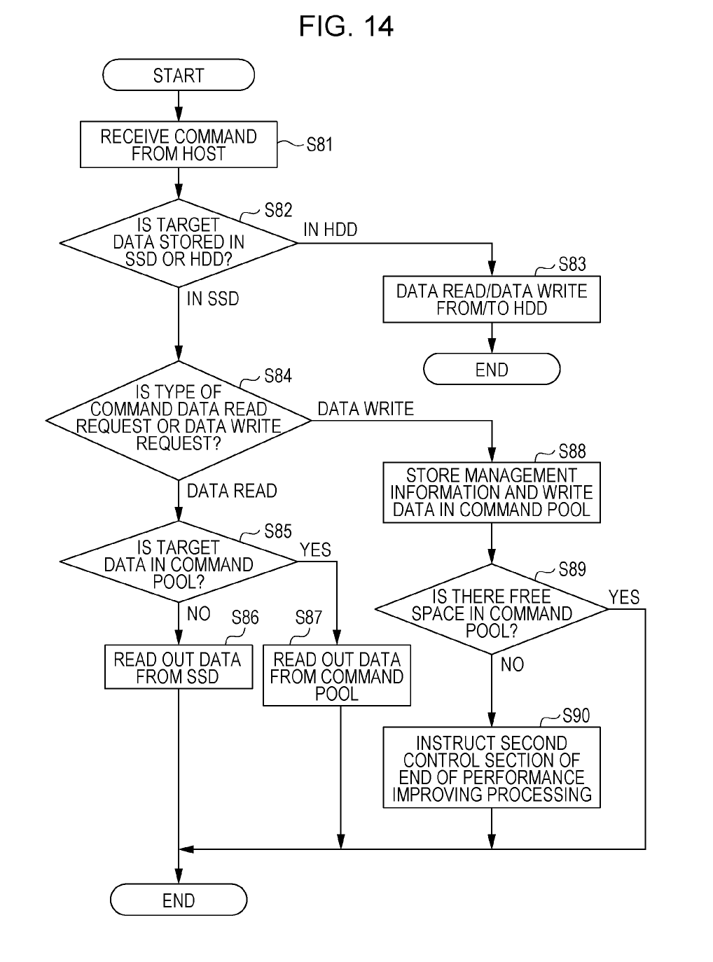

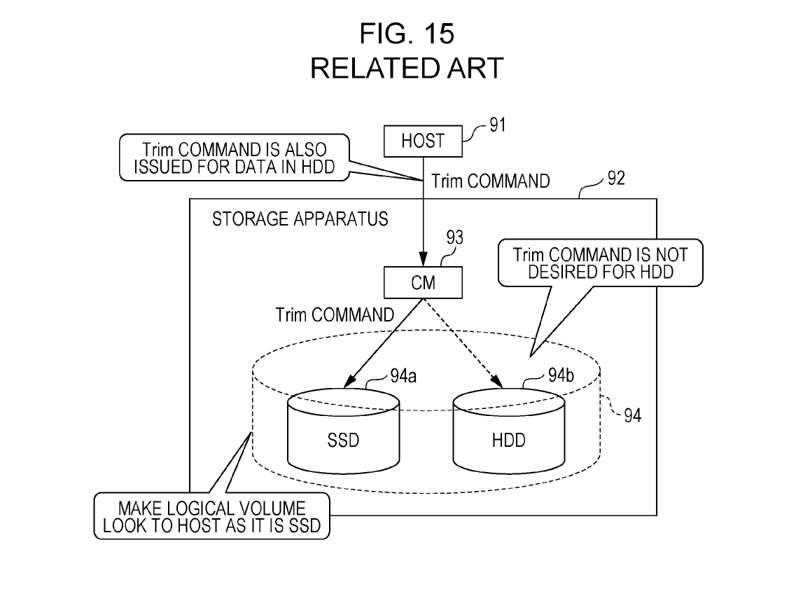

Next, a flow of processing performed by the first control section 70 when a command is received from the host 2 in a command pool use mode is described. FIG. 14 is a flow chart illustrating a flow of processing performed by the first control section 70 when a command is received from the host 2 in a command pool use mode.

As illustrated in FIG. 14, when receiving a command from the host 2 (Operation S81), the first control section 70 determines whether target data is stored in the SSD 20 or the HDD 30 (Operation S82). As a result, if the target data is stored in the HDD 30, the first control section 70 performs data read processing or data write processing to the HDD 30 (Operation S83).

On the other hand, if the target data is stored in the SSD 20, the first control section 70 determines whether the type of the command is a data read command or a data write command (Operation S84), and determines, if the type of the command is a data read command, whether or not there is first target data in the command pool 71 (Operation S85). As a result, the first control section 70 reads out, if there is not the first target data in the command pool 71, data from the SSD 20 (Operation S86) and reads out, if there is the first target data in the command pool 71, data from the command pool 71 (Operation S87).

If the type of the command is a write command, the first control section 70 stores corresponding management information and write data in the command pool 71 (Operation S88) and determines whether or not there is a free space in the command pool 71 (Operation S89). As a result, if there is not a free space in the command pool 71, the first control section 70 instructs the second control section 50 to end performance improving processing (Operation S90).

Thus, when there is not a free space in the command pool 71, the first control section 70 instructs the second control section 50 to end performance improving processing, so that data write is not lost.

As described above, in the second embodiment, when data write to the SSD 20 is executed during performance improving processing, the first control section 70 stores write data as well as management information in the command pool 71. Then, when performance improving processing is ended, the data write section 72 writes data stored in the command pool 71 to the SSD 20. Thus, the CM 60 allows data write to be performed such that data is not damaged during performance improving processing.

Also, in the second embodiment, when a data read request is generated from the host 2 during performance improving processing, the first control section 70 checks the command pool 71 and transmits, if there is target data in the command pool 71, the data of the command pool 71 to host 2. Thus, the host 2 reads out the latest data among data written during performance improving processing.

Note that, although, in each of the above-described embodiments, a storage apparatus using a SSD has been described, the present disclosure is not limited thereto but may be applied to a storage apparatus using a storage medium in which old data stored therein is erased before new data is written in a similar manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus which receives a command from a higher-level apparatus for a storage volume constructed by a plurality of storage devices one of which is a first storage device in which physically erasing data is performed on an area in which undesired data is stored in advance in preparation for next write and controls the storage devices, the storage control apparatus comprising:
an identifying section configured to identify, as an erasing area, the area in which undesired data is stored in the first storage device; and
an instructing section configured to instruct the first storage device to erase data in the erasing area identified by the identifying section.

2. The storage control apparatus according to claim 1, further comprising:
an instruction storage section configured to store a data write instruction sent from a higher-level apparatus that instructs data read and write from and to the first storage device during processing performed by the identifying section or the instructing section; and
a data write section configured to execute the data write instruction stored in the instruction storage section after the processing performed by the identifying section or the instructing section is ended.

3. The storage control apparatus according to claim 2, further comprising:
a data read section configured to determine, when receiving a data read request from the higher-level apparatus, whether or not the data read request is a data read request for readout of data that is to be written in response to the data write instruction stored in the instruction storage section and transmits, if the data read request is a data read request for readout of data that is to be written in response to the data write instruction stored in the instruction storage section, the data that is to be written to the higher-level apparatus.

4. The storage control apparatus according to claim 1, further comprising:
a measuring section configured to measure the amount of data written in the first storage device; and
a start instructing section configured to instruct, when the amount of data measured by the measuring section exceeds a predetermined threshold, the identifying section to start processing.

5. The storage control apparatus according to claim 1,
wherein the identifying section identifies the erasing area, based on a file system operated on a higher-level apparatus that instructs data read and write from and to the storage device.

6. A computer-readable recording medium having stored therein a program for causing a computer incorporated in a storage control apparatus which receive a command from a higher-level apparatus for a storage volume constructed by a plurality of storage devices one of which is a first storage device in which physically erasing data is performed on an area in which undesired data is stored in advance in preparation for next write and controls the storage devices,
wherein the control program causes the computer to execute
identifying, as an erasing area, the area in which undesired data is stored in the first storage device; and
instructing the first storage device to erase data in the erasing area identified by the identifying section.

7. A control method for controlling a storage control apparatus which receive a command from a higher-level apparatus for a storage volume constructed by a plurality of storage devices one of which is a first storage device in which physically erasing data is performed on an area in which undesired data is stored in advance in preparation for next write and controls the storage devices, the method comprising:
identifying, as an erasing area, the area in which undesired data is stored in the first storage device; and
instructing the first storage device to erase data in the erasing area identified by the identifying section.
